(19) United States
(12) Patent Application Publication
(10) Pub. No.: US 2016/0218662 A1
(43) Pub. Date: Jul. 28, 2016

(54) LIGHTWEIGHT SOLAR MODULE TRACKING DEVICE

(71) Applicant: Artur Deger, Schopfloch-Oberiflingen (DE)

(72) Inventors: Artur Deger, Schopfloch-Oberiflingen (DE); Martin Dürr, Horb (DE); Gerhard Zanker, Horb-Altheim (DE)

(21) Appl. No.: 13/719,514

(22) Filed: Dec. 19, 2012

(30) Foreign Application Priority Data
Dec. 19, 2011 (DE) 10 2011 056 583.3

(51) Int. Cl. H02S 20/32

(52) U.S. Cl. CPC H02S 20/32

(57) ABSTRACT

The subject-matter of the present invention relates to a solar system with a tracking system (100) comprising an installation and a moving device (20) for a tracking system (100) of a solar system, in particular for moving an installation connected to the moving device (20) according to a position of the sun, comprising at least one turning unit (40) rotatable about at least one elevation axis (102) with at least one receptacle (42) for receiving the installation, wherein at least the turning unit (40) and/or the receptacle (42) is/are configured asymmetrically and/or eccentrically relative to the elevation axis (102). The invention further relates to a method for producing the tracking system.

The invention relates to a moving device for a tracking system of a solar system, in particular for moving an installation connected to the moving device with respect to a position of the sun, according to the preamble of claim 1.

The invention further relates to an installation, in particular a solar installation, according to the preamble of claim 8.

Furthermore, the invention relates to a tracking system, in particular a tracking system for a solar module, for tracking at least one installation according to a position of the sun, according to the preamble of claim 12.

Moreover, the invention relates to a solar system, in particular a solar system for photovoltaic, concentrating solar energy and/or a solar heat application, according to the preamble of claim 14.

The invention also relates to a method for producing a tracking system, in particular a solar tracking system according to the invention, for tracking at least one installation, in particular an installation according to the invention, according to a position of the sun, according to claim 15.

Generally, tracking systems for solar installations, solar modules or solar panels are known from the state of the art.

Generally, tracking systems rotatable about an elevation axis are known in this context. The known tracking systems have a solar installation that is configured symmetrically. This solar installation is symmetrically connected to the tracking system. The installation is arranged in such a manner that, in a starting position, that is, in a position in which an installation is arranged in a level manner, that is, essentially horizontally, the gravitational force of the installation extends from the center of gravity of the same through the elevation axis.

DE 20 2009 005 140 U1 discloses a tracking system for a solar element having a support rotatable about an axis which is rotatable via a drive member, and a coupling element fixable to an anchor which has an axial bearing surface for the support and forms a receptacle into which an anchor can be inserted and clampingly fastened via fasteners. This solution has an installation and/or turning unit which is arranged symmetrically. The support arms have a large overhang to allow high torques to be reached. In particular, a distance between an azimuth rotation plane and the elevation axis is here relatively large.

DE 101 92 244 discloses a tracking system for tracking a collector, absorber, reflector or photovoltaic module according to the position of the sun, with a planar support rotatable about a first axis of rotation and a second axis of rotation, wherein the first axis of rotation extends essentially horizontally and the second axis of rotation extends essentially vertically, the planar support is rotatably fixed to a receiving support at at least two support points in the first axis of rotation and the receiving support is fixed to a stand pillar so as to be rotatable about the vertical axis of rotation, wherein the receiving support comprises at least one upper crossbar to which are fixed lateral supports which are connected to a lower crossbar, wherein the crossbars comprise a bearing in their center by means of which the receiving support is rotatably mounted on the stand pillar and wherein the receiving support comprises a lateral guidance for traction means which is cylindrically curved around the second axis of rotation and through which traction means are guided. This known solution has a symmetrical installation, too, wherein unfavorable torques may appear due to long lever arms.

DE 32 29 248 A1 discloses a support structure for an array of solar cells. The array comprises an array of stiffening elements or stiffening beams and an array of silicon solar cells. The array of beams has two elongated straight beams which extend from one edge to the opposite edge of a substrate. Connected between the beams are two parallel beams interconnected by a central beam so that the three beams form an H structure. This structure has the advantage of providing stiffness to the substrate with relatively few beams.

Each of the beams of the beam array is identical in its cross-section. Each beam comprises several layers of different materials. The core material is a woven epoxy-reinforced carbon fiber material. The threads of the core fabric are oriented in two directions orthogonal to each other. The fabric is shaped to form a channel having a base member and two legs. Horizontal flanges extend in opposite directions from the legs.

The array is designed as a lightweight structure for astronautics and comprises beams consisting of joined fibers. The layout of the beams is a U shape with flanges on the legs which extend outwards. The array is not designed for large loads.

It is an object of the present invention to provide a trackable solar system which is more lightly constructed, accordingly easier to transport and to install and withstands the high loads imposed by weight and/or wind forces, in particular by an optimized load distribution.

It is also an object of the present invention to provide a method for producing the same.

These and further objects are achieved based on a moving device according to claim 1, an installation according to claim 8, a tracking system according to claim 12, a solar system according to claim 14 and a method for production according to claim 15 in connection with their characteristic elements. Advantageous developments of the invention are given in the dependent claims or below in connection with the description of the figures.

The invention includes the technical teaching that, for a moving device for a tracking system of a solar system, in particular for moving an installation connected to the moving device according to a position of the sun, comprising a turning unit rotatable about at least one elevation axis with a receptacle for receiving the installation, it is provided that the turning unit and/or the receptacle is/are configured asymmetrically and/or eccentrically relative to at least the elevation axis.

The moving device comprises at least one turning unit. The turning unit is configured rotatable relative to the remaining parts of the moving device, in particular rotatable about the elevation axis. In one embodiment, there is provided exactly one turning unit. In other embodiments, there are provided multiple turning units. The multiple turning units are, in one embodiment, at least partially integrated with each other. In other embodiments, the turning units are configured as separate units. The turning units are, in one embodiment, configured identically. In other embodiments, the turning units are at least partially configured differently. It is preferred to provide one turning unit.

For an installation to be rotatable via the turning unit, the turning unit comprises a receptacle. In one embodiment, the receptacle is configured as an integrally molded element. In a preferred embodiment, the receptacle is configured as a recess, in particular as a groove. In one embodiment, the turning unit comprises one receptacle. In another embodiment, the turning unit comprises multiple receptacles.

The turning unit is arranged rotatably about an elevation axis. The turning unit is capable of being pivoted and/or rotated from a non-rotated or non-deflected starting position into at least one pivoted position or operating position.

Starting state or starting position for the purposes of the present invention means a position in which the moving device is not pivoted, in particular not pivoted about an elevation axis The starting position is such that an installation arranged on the moving device is arranged in an essentially horizontal and/or level manner. More precisely, the turning unit is not pivoted but it is in a non-rotated starting position.

The turning unit is preferably capable of being continuously pivoted into various operating positions. In another embodiment, the turning unit is capable of being pivoted into various operating positions in an at least partially stepwise manner. The turning unit is designed asymmetrically. The turning unit is in particular configured asymmetrically in relation to the elevation axis. The turning unit is in particular configured asymmetrically with respect to the elevation axis. The turning unit is in particular configured asymmetrically, in particular with respect to the elevation axis, when it is in a non-deflected or non-pivoted situation, that is in a starting position. In an asymmetric embodiment, a center of mass and/or centroid of the volume of the turning unit extends in the direction of a gravitation field, that is, approximately in vertical direction, in an offset manner relative to a vertical or centroid line through the elevation axis. That is, the weight force through the centroid of the volume and/or the center of mass is offset relative to a parallel vertical through the elevation axis. In one embodiment, an axis which extends through the center of mass and/or the centroid of the volume of the turning unit in the same direction as the elevation axis is parallel, that is, laterally offset relative to the elevation axis.

The same applies to the receptacles. The receptacle is configured asymmetrically. The receptacle is in particular configured asymmetrically with respect to the elevation axis. In a non-deflected or non-pivoted situation, that is in a starting position, the receptacle is preferably configured asymmetrically, in particular with respect to the elevation axis. In an asymmetric embodiment, a center of mass and/or centroid of the volume of the receptacle extends in the direction of a gravitation field, that is, approximately in vertical direction, in an offset manner relative to a vertical or centroid line through the elevation axis. That is, the weight force through the centroid of the volume and/or the center of mass is offset relative to a parallel vertical through the elevation axis. In one embodiment, an axis which extends through the center of mass and/or the centroid of the volume of the receptacle in the same direction as the elevation axis is parallel, that is, laterally offset relative to the elevation axis.

One embodiment of the invention provides that the receptacle is arranged transversely with respect to a direction from the elevation axis towards the installation and/or a vertical through the elevation axis, in particular laterally and/or in the opposite direction. The receptacle is in particular arranged transversely relative to a direction from the elevation axis towards the installation in a starting position, in particular laterally and/or in the opposite direction. In the starting position, the direction is vertical or, more precisely, along a gravitation field of the earth. In the starting position, the main surfaces of the usually planar installation are essentially aligned horizontally. That is, the vertical forms a surface normal relative to the planar installation. The receptacle, more precisely its center of mass and/or centroid of the volume, is arranged in an offset manner with respect to the surface normal. The offset is formed in vertical direction and/or in horizontal direction. If a horizontal plane is laid through the elevation axis, the center of mass and/or the centroid of the volume of the receptacle in the plane is arranged in an offset manner with respect to the elevation axis and/or in another plane. The center of mass and/or the centroid of the volume is preferably in another plane which is closer to the Earth's center than the horizontal plane of the elevation axis. When the turning unit is turning, the relations change accordingly so that the planes turn, too, due to the rotation. The center of mass and/or the centroid of the volume is then on the left or on the right below or above the plane of the elevation axis, dependent on the rotation. The distances of the planes remain constant. In one embodiment, the center of mass and/or the centroid of the volume of the receptacle in a starting position is preferably laterally offset and closer to the Earth's center than the elevation axis.

In another embodiment, it is provided that the turning unit comprises at least one overhanging lever arm. The lever arm is arranged on one end in the area of the elevation axis. From there, the lever arm laterally overhangs the elevation axis. In the starting position, the lever arm approximately horizontally overhangs the elevation axis. In a preferred embodiment, the turning unit is configured as an overhanging lever arm. In another embodiment, the turning unit comprises multiple overhanging lever arms. The lever arms are, in one embodiment, configured identically. In another embodiment, the lever arms are at least partially configured differently. It is preferred to provide a single lever arm. In another advantageous embodiment, there are provided multiple lever arms, for example two, three, four or more lever arms, which are spaced from each other. In one embodiment, the lever arms are equally spaced from each other. In another embodiment, the lever arms are differently spaced from each other. In still another embodiment, the lever arms are arranged in a stationary manner with respect to each other, that is, with a fixed distance to each other. In another embodiment, the lever arms are arranged variably with respect to each other. A preferred embodiment provides that the lever arms are connected to each other, in particular rigidly connected to each other. The lever arms are preferably configured in one piece with each other.

The receptacle is preferably formed on the overhanging lever arm. The receptacle is preferably formed on an end of the lever arm adjacent to the elevation axis. In one embodiment, the receptacle is in the starting position configured in a laterally offset manner relative to the elevation axis. A connecting area for the connection to an actuator is preferably formed on the end distant from the elevation axis. A torsional force is introduced via the actuator into the lever arm so as to enable the latter to pivot about the elevation axis. It is further preferred that the receptacle is formed as close as possible to an upper edge of the turning unit in the direction of the azimuth axis so that the central support is arranged at the smallest possible distance from the turning unit. The distance from the center line of the elevation axis to the upper side of the turning unit facing the elevation axis is, in the direction of the azimuth axis, preferably less than 250 mm, more preferably less than 150 mm, and most preferably less than 100 mm.

Due to the overhanging shape, the lever arm is configured asymmetrically, at least with respect to the elevation axis.

Another embodiment of the invention provides that there is provided at least one further moving unit in order to move the connected installation in the direction of at least one further degree of freedom of the moving device. In one embodiment, there is provided another moving device. In still another embodiment, there are provided multiple moving devices. The further moving device is, in one embodiment, configured as a translational moving device. In another embodiment, the further moving device is provided as a rotational moving device. Still another embodiment provides a translational and rotational moving device. The further moving device is, in one embodiment, configured as a separate component. In another embodiment, the moving devices are integrated, in particular configured as one component. Each moving device has a degree of freedom of at least one, that is, the moving device is designed for a movement with at least one degree of freedom. Preferably, there is formed at least one second moving device. The second moving device is preferably configured as second turning unit, wherein the second turning unit is configured as a turning unit rotatable about an azimuth axis. The azimuth axis is preferably configured vertically relative to the elevation axis. The azimuth axis is orientated vertically or in the direction of the centroid lines.

The moving device thus comprises two moving units. One moving unit is configured as first turning unit which is rotatable about the elevation axis. The other moving unit is configured as second turning unit which is rotatable about the azimuth axis. In this way it is possible to perform tracking according to a position of the sun by means of the moving device.

Another embodiment of the invention provides that one of the further moving units is configured as a motion drive which is rotatable at least about an azimuth axis. The second moving unit is preferably configured as second turning unit. The second turning unit is configured as a rotatable motion drive. To this end, the second turning unit comprises an actuator, for example a motor, a linear drive or the like. The motion drive preferably comprises a gear. The gear is for example configured as an angle gear and/or a transmission gearing. In one embodiment, the gear comprises a worm gear. Via this worm gear it is possible to control the motion drive. An advantageous embodiment thus provides that the motion drive is a gear which enables a rotation of the moving device about an azimuth axis, that is, a vertical axis. In other embodiments, there is provided a moving device which is movable about at least one translation axis. Preferably, there is provided one gear. The gear is configured for connection to a stand pillar or the like. To this end, the gear comprises a corresponding adapter or connector.

The second turning unit, that is, the motion drive, preferably comprises a swing bearing. The swing bearing is preferably arranged in a casing. In one embodiment, the swing bearing is configured in the manner of a ball bearing or the like. It preferably comprises two rings which are movable relative to each other and are designed for axial load input. Other embodiments are also applicable.

Furthermore, one embodiment provides that the moving device comprises at least one bearing unit for rotatably bearing the turning unit. In one embodiment, there is provided one bearing unit. In another embodiments, there are provided multiple bearing units. For the turning unit to be rotatable about the elevation axis, it is supported with a corresponding bearing unit. The bearing unit is preferably formed on the further moving unit. The bearing unit is in particular formed on a casing of the second turning unit. To this end, the bearing unit comprises at least one bearing bracket with a bearing position. Preferably, there are provided multiple bearing brackets with one bearing position each, in particular two bearing brackets spaced from each other. The distance of the bearing brackets is dimensioned such that a width of the bearing formed by the bearing brackets is narrower than a width of the turning unit around the azimuth axis. The width of the bearing is preferably less than 100% of the width of the turning unit projected in the direction of the bearing, more preferably less than 95% of the width, even more preferably less than 90%, and most preferably less than 85% of the width. The distance of the bearing brackets to the azimuth axis is minimized. The distance is preferably less than 50% of the diameter of the turning unit, more preferably less than 45% of the diameter, and most preferably less than 40% of the diameter. The diameter is measured radially from the azimuth axis in the direction of the casing to the outer swing bearing of the turning unit.

The bearing position preferably comprises a rolling bearing and/or a slide bearing. The respective bearing position is preferably configured as a passable bearing position through which may extend a shaft element or axle element. The shaft element or axle element whose center axis forms the elevation axis is arranged between the bearing positions or extends through them. The axle element is connected to the first turning unit so that this first turning unit is supported rotatably about the elevation axis. The turning unit is rotatable about the elevation axis by actuation of the actuator arranged distant from the elevation axis. The receptacle is rotated about the elevation axis together with the turning unit. This causes an installation received in the receptacle to rotate about the elevation axis, too.

An advantageous embodiment of the invention provides that the bearing unit and the at least one further moving unit are configured in an integrated manner. The bearing unit is preferably fixed to the moving unit, in particular nondetachably fixed. A casing of the moving unit or parts of the moving unit are advantageously configured in one piece with parts of the bearing unit. The casing and the bearing unit are preferably configured in one piece with each other, for example as a cast part. In other embodiments, the bearing unit and the moving unit are welded together or otherwise firmly bonded together. The bearing unit then projects above the further moving unit in vertical direction, that is, in the direction of the azimuth axis and in the direction of the installation. The bearing unit is preferably configured in an offset manner relative to the azimuth axis. That is, a center of mass and/or a centroid of the volume of the bearing unit extends in an offset manner, that is, non-coaxially, relative to the azimuth axis. In this way, the bearing unit is arranged asymmetrically and/or eccentrically relative to the azimuth axis and to the turning unit.

The invention includes the technical teaching that for an installation, in particular a solar installation, comprising at least one support structure pivotable about an elevation axis and/or at least one solar module, it is provided that the installation is configured asymmetrically, at least with respect to the elevation axis.

The installation is preferably configured as a solar installation. To this end, the installation comprises at least one solar module. A solar module for the purposes of the invention is selected from the group comprising collectors, absorbers, reflectors and/or photovoltaic modules, that is, any module which is used for the conversion of solar energy. The solar modules are preferably planar, that is, they are small in one dimension direction compared to the other dimension directions. The solar module is preferably configured as a plate-type body with a solar side and an opposite installation side. The solar module is, in one embodiment, rectangular and/or square. In other embodiments, there are provided other shapes, for example round or polygonal shapes. The installation preferably comprises multiple solar modules. The multiple solar modules are preferably configured identically. In another embodiment, at least two solar modules are configured differently. The solar modules are preferably configured symmetrically, in particular symmetrically when seen from above, for example as a rectangle, a square or a circle. More preferably, the installation comprises multiple solar modules arranged in a row and/or column. In one embodiment, the solar modules are adjacent. In another embodiment, the solar modules are spaced from each other, in particular equally spaced from each other. In this way, there is realized a solar module matrix or a solar module field. The solar module array is, in one embodiment, configured symmetrically. In another embodiment, the solar module array is configured asymmetrically. The solar module array comprises in particular a centroid of the volume and a center of mass. In one embodiment, the centroid of the volume and the center of mass coincide with each other. In another embodiment, the centroid of the volume and the center of mass are offset relative to each other, at least in one direction. It is preferred that a vertical through the centroid of the volume and/or the center of mass extends in an offset manner relative to a vertical through the elevation axis, in particular in a starting position.

In one embodiment, the installation further comprises a support structure. The at least one solar module is connected to the support structure. In one embodiment, the support structure comprises a rail unit or multiple rail units. The rail units are, in one embodiment, configured identically. In another embodiment, the rail units are configured differently. The rail units are preferably configured identically. The rails units are preferably configured as profiles, profile rails and the like. The rail units are configured so as to fix the solar modules, in particular to fix them in a detachable and/or adjustable manner. The rail units are preferably spaced from each other, in particular equally spaced from each other. In one embodiment, the rail units are configured symmetrically. In another embodiment, the rail units are configured asymmetrically. One embodiment provides that the solar modules and/or the rail units are configured symmetrically. Another embodiment provides that the solar modules and/or the rail units are configured asymmetrically. The common center of mass or the centroid of the volume of the solar modules and the rail units coincide or not with the centroid of the volume and/or the center of mass of the solar modules and the rail units. In one embodiment, the center of mass of the rail units differs from the centroid of the volume of the rail units.

An envelope around the rail units or a space spanned by the rail units is here considered, in particular for the centroid of the volume.

The installation or the support structure further comprises a central support.

Accordingly, it is provided that the installation or the support structure comprises a central support which is suitable to be received in the receptacle of the moving device. The central support is preferably arranged asymmetrically and/or eccentrically relative to the installation, in particular with respect to a gravity center of the installation. The central support is configured for connection of the installation to the moving device. The central support comprises at least one area which is configured for interaction with the receptacle of the moving device. To this end, the area of the central support has a contour adapted to the receptacle. The interacting contours are preferably configured complementarily. The contour of the central support is in the area for interaction preferably rotationally asymmetric so as to avoid any twisting of the central support in the receptacle.

The rail unit is, in one embodiment, directly connected to the central support. In another embodiment, the rail units are indirectly connected to the central support, for example via a support frame which is connected to the central support.

The rail unit or general the connection unit for connecting the solar module or the solar modules to the central support are in principal freely configurable. In one embodiment, there is provided one connection unit. In other embodiments, there are provided multiple connection units. The connection units are for example configured as rails, profiles, sheets or other simple components. In one embodiment, the connection units are detachably connected to the central support. In another embodiment, the connection units are nondetachably connected to the central support, for example firmly bonded by gluing, welding, soldering or the like. A preferred embodiment provides that the connection units are movable along the central support and/or lockable at a desired position on the central support. To this end, the connection units comprise corresponding locking means. At least one of the connection units is, for example, configured as a trapezoidal sheet with a recess. The recess corresponds to the central support which is received in the recess. The trapezoidal sheet is accordingly movable along the central support and lockable at a desired position. There are preferably provided multiple trapezoidal sheets to which the solar modules can be directly or indirectly connected. The recess preferably has a rotationally asymmetrical cross-section so as to avoid twisting of the trapezoidal sheet relative to the central support.

In one embodiment, it is accordingly provided that the installation, except for the central support, where appropriate, is barrier-free. The freedom of barrier is in particular also realized when the installation is maximally pivoted about the elevation axis. Barrier-free for the purposes of the present invention means that modules of any depth can be used without collisions occurring between the modules and a frame element. One embodiment accordingly provides that the connection units are directly arranged on the central support without any further frame element, for example a transverse support, a longitudinal support, a support frame or the like being required.

In a preferred embodiment of the present invention, it is provided that the central support is arranged asymmetrically and/or eccentrically relative to the installation, in particular with respect to a gravity center of the installation. In one embodiment, the center of mass and/or the centroid of the volume of the central support differs from the center of mass and/or the centroid of the volume of the solar module or the solar module array. In a further embodiment, the center of mass and/or the centroid of the volume of the central support differs from the center of mass and/or the centroid of the volume of the rail unit or the rail units. In still another embodiment, the center of mass and/or the centroid of the volume of the central support differs from the common center of mass and/or centroid of the volume of the rail unit or the rail units and the solar module or the solar modules. In yet another embodiment, the centroid of the volume of the central support differs from the common center of mass of the rail unit, the solar module and the central support. In another embodiment, the centroid of the volume of the central support differs from the center of mass of the central support.

The deviations or the correspondence of the center of mass and/or the centroid of the volume of the individual components are in particular to be understood with respect to a starting position or starting state. That is, the deviations and/or the correspondence refer(s) to a starting position in which no rotation about the elevation occurred. A deviation means here a significant deviation, that is, a deviation which is not due to tolerances or inaccuracies in production. It rather means a design-related, in particular intended and not merely coincidental or unintended deviation.

Another embodiment of the present invention provides that the installation or the support structure comprises at least one further support connected to the central support. The installation preferably comprises multiple further supports, for example a support frame. The central support and the further support or the further supports are, in one embodiment, configured as separate units. The central support and the further support, for example the support frame, are preferably connected to each other. Accordingly, the support frame comprises, in one embodiment, an exterior frame and at least the central support which preferably connects two supports of the exterior frame, in particular without the use of struts.

A strut for the purposes of the invention is a preferably diagonal component which serves for the dissipation of forces, in particular compressive and/or shear forces and/or for reinforcement. The strut is formed on two differently oriented sections. Struts for the purposes of the invention also comprise diagonal wire connections which connect, for example, a transverse support and a longitudinal support. The support frame according of the invention has no struts, that is, the support frame has no diagonal components.

The support frame rather comprises the exterior frame. The exterior frame comprises at least three supports which are connected to each other. The exterior frame preferably comprises four supports which are arranged in the manner of a window frame, that is, in a rectangular or square manner when seen from above. Two supports are configured as longitudinal supports and are situated opposite each other, in particular spaced apart in parallel. Two supports are configured as transverse supports and are also situated opposite each other, in particular spaced apart in parallel. The transverse supports are arranged crosswise, in particular at right angels or nearly at right angles with the longitudinal supports. In other embodiments, the exterior frame comprises more than four supports, wherein each support is connected to the ends of two adjacent supports so as to form an exterior frame. The supports are preferably in one plane. In other embodiments, there are also arrangements with supports which protrude from the plane, that is, which are arranged in planes situated transversely to each other and/or in a skewed manner relative to each other.

The supports are preferably configured as profiled supports. In one embodiment, the supports are configured as a solid profile, for example as an I-beam, double-T beam or the like. In other embodiments, the supports are configured as a hollow profile, for example as an O-shaped profile or the like. Each support of the exterior frame preferably has the same profile, for example an I-shaped profile. In other embodiments, at least one support has a profile that differs from that of the other supports.

Given the fact that the exterior frame, depending on its size and dimensions, does not easily withstand larger loads, such as those caused by wind loads and/or weight forces resulting from received solar modules, for a longer period, the exterior frame comprises at least the inner central support. The at least one central support connects two supports spaced from each other. In one embodiment, the central support connects two cross struts to each other. To this end, the central support is preferably configured parallel relative to the longitudinal supports connected to the transverse supports so that the central support is arranged approximately vertically relative to the transverse supports. The central support extends longitudinally through the whole space spanned by the exterior frame. The central support is preferably arranged eccentrically relative to the transverse supports. That is, the center of mass and/or the centroid of the volume of the central support differs from the center of mass and/or the centroid of the volume of the frame.

In one embodiment, the supports are configured as steel supports. In another embodiment, the supports are configured as plastic supports. The supports are preferably made of a single material, preferably a corrosion-resistant material. In one embodiment, the supports have a coating so as avoid corrosion.

One embodiment of the invention provides that the exterior frame is formed by two longitudinal supports and two transverse supports which connect the longitudinal supports to each other without the use of struts. Thus, an exterior frame is created which is rectangular or square when seen from above and which is in particular suited for rectangular or square solar modules. The solar modules can thus be connected to the exterior frame via connection elements.

In a further embodiment, it is provided that the inner central support is connected to the two transverse supports. Instead of providing struts, that is, components which connect longitudinal supports and transverse supports, the central support is configured as a longitudinal element which connects the two transverse supports to each other. The central support is preferably configured essentially vertically with respect to the transverse supports. In another embodiment, the central support is connected to the two longitudinal supports. The central support is preferably firmly bonded to the transverse supports, for example by welding.

The invention also includes the technical teaching that for a tracking system, in particular a tracking system for a solar module, for tracking at least one installation according to a position of the sun, comprising at least one moving device and at least one installation, it is provided that the moving device is configured as a moving device according to the invention and/or the installation is configured as an installation according to the invention. The tracking system comprises the installation coupled to the moving device. In a preferred embodiment, there is provided a control which controls the moving device according to the position of the sun. To this end, one embodiment provides an automatic control. This automatic control identifies a position of the sun and controls the moving device accordingly. In another embodiment, there is provided a computer-based control which calculates the position of the sun depending on the current location and controls the moving device accordingly. Manual controls can also be provided.

The invention also includes the technical teaching that for a solar system, in particular a solar system for photovoltaic, concentrating solar energy and/or a solar heat application, comprising at least one moving device and at least one installation coupled to the moving device with at least one solar system module, it is provided that the installation is configured as an installation according to the invention and/or the moving device is configured as a moving device according to the invention. The solar system module is for example configured as a solar collector, reflector or the like. The moving device is preferably arranged on a stand pillar or the like. The stand pillar is for example adjustable in height.

Moreover, the invention further includes the technical teaching that for a method of production of a tracking system according to the invention, in particular a solar tracking system according to the invention, for tracking at least one installation, in particular an installation according to the invention, according to a position of the sun, wherein one installation is arranged on a moving device, in particular a moving device according to the invention, it is provided that the installation is arranged asymmetrically on the moving device. The method of production according to the invention is in particular faster to perform. In one embodiment, the moving device is, for example, pre-mounted or produced in one piece. This eliminates the need to create a base for the mounting of a moving device which is, for example, configured as a rotating head. The moving device is directly mounted to a stand pillar or another support structure. To this end, there are provided corresponding connecting surfaces, flanges and/or connecting pieces. The connection is made, for example, by screwing. One support frame is mounted on site. The strut-free design eliminates the need for strutting. Only the central support is mounted eccentrically. Furthermore, the production time is significantly reduced due to the reduced number of parts. The entire mounting of the solar system is in particular performed in less than 400 min, preferably in less than 300 min, more preferably in less than 200 min, and most preferably in less than 150 min.

In one embodiment, the solar module is fixed on the rail unit and then on the support frame. The rail unit is preferably fixed to the support frame by screwing. The support frame is connected to the moving device by inserting the central support into the receptacle. To do this, the moving device is in a starting position. The moving device is fixed to the stand pillar. This is preferably done prior to the mounting of the central support on the moving device.

In summary, the following benefits can be achieved.

The solution according to the invention is considerably compacter than the state of the art. Compared to the state of the art, preferably 200% more systems can be sent in one transport unit, more preferably 220% more systems, even more preferably 240% more systems can be sent in one transport unit, with reference to an identical module surface. That is, in the case of a system having a module surface or being designed for a module surface of 70 m², for example, space savings, volume savings or packing volume savings of about 200%, preferably of about 220%, more preferably of about 240%, and most preferably of about more than 250% are achievable.

Moreover, the solution is lighter than the state of the art. Compared to the state of the art, the weight reduction of the overall system with respect to an identical module surface is preferably 20%, more preferably 25% weight reduction of the overall system, even more preferably 30% weight reduction of the overall system. The overall system comprises at least the turning units, that is, the moving head, preferably the turning units plus the installation. Not included is the foundation. Included may be the mast or the support structure without foundation. There are considerable benefits, in particular with respect to the ratio of the module surface to a packing volume or a weight of the components.

A transport unit for the purposes of the present invention preferably means a cuboid-shaped container or the like.

In the following, the invention is described in more detail by means of embodiments represented in the drawings. Uniform reference signs are used here for identical or similar components or features. Features or components of different embodiments may be combined to obtain further embodiments. All features and/or advantages disclosed in the claims, the description or the drawings, including constructive details, spatial arrangements and method steps can be essential to the invention both individually and in a great variety of combinations.

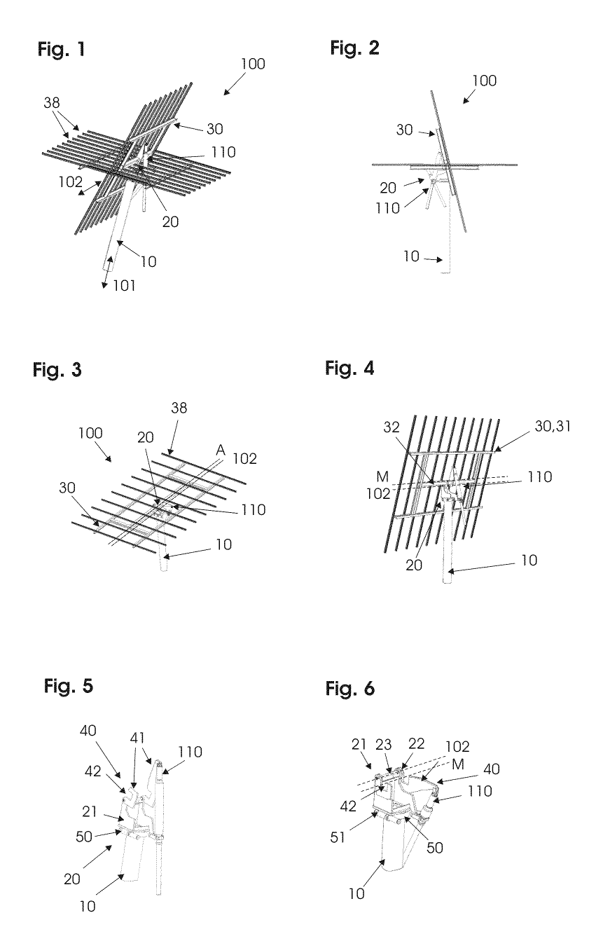

FIG. 1 schematically shows a perspective view of a tracking system with a support frame in two differently deflected positions;

FIG. 2 schematically shows a side view of the tracking system according to FIG. 1,

FIG. 3 schematically shows a perspective view of the tracking system according to FIG. 1 with the support frame in a first, non-deflected position;

FIG. 4 schematically shows a perspective view of the tracking system according to FIG. 1 with the support frame in a second, deflected position;

FIG. 5 schematically shows in a perspective view a cut-out of the tracking system according to FIG. 1 in the second deflected position, without the support frame;

FIG. 6 schematically shows in a perspective view a cut-out of the tracking system according to FIG. 1 in the first, non-deflected position, without the support frame;

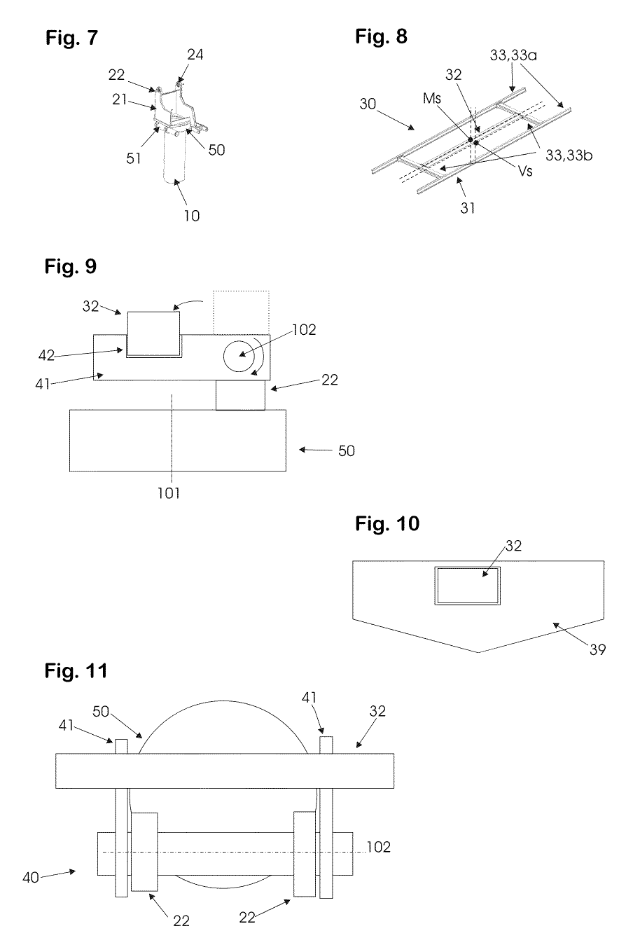

FIG. 7 schematically shows in a perspective view the cut-out according to FIG. 6 without actuator and without the receptacle for the support frame;

FIG. 8 schematically shows in a perspective view the cut-out according to FIG. 1 without the stand pillar;

FIG. 9 schematically shows in a cross-sectional view the arrangement of the central support;

FIG. 10 schematically shows in a side view the central support with movable trapezoidal sheets, and

FIG. 11 schematically shows in a top view the moving device with the central support.

FIG. 1 schematically shows a perspective view of a tracking system 100 with a support frame 30 in two differently deflected positions. The tracking system 100 is configured as a tracking system for a solar module for tracking at least one collector, absorber, reflector and/or photovoltaic module according to a position of the sun. For this purpose, the tracking system 100 comprises a stand pillar 10, a moving device 20 configured as a moving head and an installation of which only the support frame 30 including the rail unit 38 is shown here. The support frame 30 is connected to the stand pillar 10 via the moving device 20. The connection is configured such that the support frame 30 is connected to the stand pillar 10 so as to be rotatable about at least one axis of rotation 101, 102. In the represented embodiment, there are provided two axes of rotation 101, 102. A first axis of rotation 101 is configured as a vertical axis of rotation or azimuth axis 101. It extends approximately vertically through the stand pillar 10. A second axis of rotation 102 is configured as a horizontal axis of rotation or elevation axis 102 and extends vertically with respect to the first axis of rotation 101 in a latitude direction of the installation. The moving device 20 is coupled to the stand pillar 10 so as to be rotatable about the first axis of rotation 101. The support frame 30 is coupled to the moving device 20 so as to be rotatable about the second axis of rotation 102. The rail units 38 for the reception of solar modules or solar panels and the like are formed on the support frame 30. The rail units 38 are configured as profiles, profile rails and the like. They are arranged on the support frame 30 at approximately the same distance from each other and/or parallel to each other. The rail units 38 protrude from the support frame 30. The rail units 38 are formed permanently on the support frame 30. An actuator 110 is provided for pivoting or turning the installation about the elevation axis 102. In the present embodiment, the actuator 110 is configured as a linear actuator. It acts on an outer area of the moving device 20. The installation, more precisely, the support frame 30 with the rail units is shown in two different states or positions. In a first position, the installation is in a starting position or starting state. In this position, the installation is oriented in an approximately horizontal or level manner. In a second, deflected position, the installation is shown after being rotated about the elevation axis 102 by approximately 85° compared to the starting position. The two different positions are shown more clearly in FIG. 2.

FIG. 2 shows schematically a side view of the tracking system 100 according to FIG. 1. The view is taken from or in the direction of the elevation axis 102. Identical reference signs are used for identical or similar components. Detailed description of components already described is omitted. In the side view, the two deflected states or positions of the installation or the support frame 30 and the rail units 38 and the moving device 20 are easily to distinguish. In the first position, that is, in the starting state, the support frame 30 including the rail units 38 is orientated approximately horizontally, that is, the support frame 30 and the plane spanned by it are approximately parallel relative to a ground not shown here which extends essentially horizontally in that region. In the deflected second position, the support frame 30 is pivoted by approximately 80° to 85° compared to a horizontal, that is, about the elevation axis 102. Pivoting is done via the actuator 110 which is arranged on the moving device 20 and the support frame 30. The actuator 110 is configured as a linear actuator or stroke actuator. The support frame 30 is pivoted about the elevation axis 102 into the second position by extracting a piston or generally a controlling element. Retraction of the controlling element causes the support frame 30 to pivot about the elevation axis 102 in the direction of the first position. The two positions are shown separately in FIG. 3 and FIG. 4.

FIG. 3 shows schematically a perspective view of the tracking system 100 according to FIG. 1 with the support frame 30 and the rail units 38 in the first, non-deflected position. The support frame 30 spans here a plane which is essentially arranged horizontally. This position is optimal for a position of the sun where the sun is for example vertical above the support frame. This corresponds to a first extreme position. The support frame 30 and the solar modules arranged on it are orientated in such a manner that the sun's rays fall vertically on the solar module and the support frame 30 to ensure optimal solar energy yield. A second extreme position is shown in FIG. 4. There is also shown the asymmetric arrangement of a central support 32 of the support frame 30. The central support comprises a center axis A which, in the starting position, is offset with respect to the elevation axis 102, wherein the offset is shown here in an exaggerated manner for clarification purposes. The center axis A extends parallel relative to the elevation axis 102 through a centroid of the volume and/or a center of mass of the central support 32.

FIG. 4 shows schematically a perspective view of the tracking system 100 according to FIG. 1 with the support frame 30 in a second deflected position. In this position, the support frame 30 is pivoted by approximately 80° to 85° compared to the position in FIG. 3. This position corresponds approximately to a low position of the sun in which the sun is still able to illuminate the support frame 30. Here it is clearly visible how the actuator 110 is extracted so that the support frame 30 is pivoted about the elevation axis 102. The support frame 30 is configured as an exterior frame 31 which comprises the interior central support 32. The more detailed description of the support frame 30 is given at FIG. 11. FIG. 4 clearly shows the offset of the elevation axis 102 and the center axis M extending through the center of mass and/or the centroid of the volume of the central support 32 in a parallel offset manner relative to the elevation axis 102.

FIG. 5 shows schematically in a perspective view a cut-out of the tracking system 100 according to FIG. 1 in the second deflected position, without the support frame. Here, the moving device 20 is clearly represented. In the shown embodiment, the moving device 20 comprises a turning unit 40 rotatable about the elevation axis 102. The turning unit 40 comprises two overhanging lever arms 41 which are connected to each other and spaced apart from each other. The lever arms 41 are configured with a different overhang. A receptacle 42 is formed in each of the lever arms 41 so as to be aligned in the direction of the elevation axis 102. The receptacle 42 is configured as a groove with an approximately rectangular cross-section so that the rectangular contour corresponds to the corresponding outer contour of the central support 32. Furthermore, the moving device 20 comprises a bearing unit 21 for bearing the turning unit so as to be rotatable about the elevation axis which is shown more clearly in FIG. 6. Moreover, the moving device 20 comprises a further turning unit 50 for rotation of the moving device 20 about the azimuth axis 101.

FIG. 6 schematically shows in a perspective view a cut-out of the tracking system according to FIG. 1 in the first, non-deflected position, without the support frame. In this view, the offset of the receptacle 42 with respect to the elevation axis 102 is clearly visible. Due to this offset, the central support 32 is also arranged in an offset manner relative to the elevation axis 102. The turning unit 40 is connected to the bearing unit 21 so as to be rotatable about the elevation axis 102. The bearing unit 21 comprises two bearing brackets 22 spaced from each other with corresponding bearing positions for the reception of a shaft element or axle element 23. The elevation axis 102 forms the center axis of the axle element 23. The turning unit 40 is non-rotatably connected to the axle element 23. The axle element 23 is supported at the bearing position via a ball bearing. Extraction of the linear actuator 100 thus causes the turning unit 40 to pivot about the elevation axis. Also shown is the second turning unit 50 which here comprises an actuator 51 for performing an actuator-driven rotation of the moving device 20 about the azimuth axis 101.

A fixation section of the actuator 110 on the bearing unit 21 is configured approximately fork-shaped. Two bearing positions for receiving an axis are provided to support the actuator 110 on the fixation section so that the actuator 110 is rotatably received on the fixation section.

FIG. 7 schematically shows in a perspective view the cut-out according to FIG. 6 without the actuator and without the turning unit 40. The represented bearing unit 21 comprises two bearing positions 24 configured as through holes in which the axle element 23 is supported.

FIG. 8 schematically shows in a perspective view the support frame 30 alone according to FIG. 1. In the present embodiment, the support frame comprises an exterior frame 31 with two longitudinal supports 33a and two transverse supports 33b which are arranged alternately, approximately at right angels with each other. The central support 32 extends between the transverse supports 33b. The central support 32 is vertically connected to the transverse supports 33b. Cross struts or the like, that is, diagonal elements which connect the differently orientated supports 33a, 33b with each other are not provided so that the support frame 30 is configured without struts, in particular without cross struts. The central support 32 is arranged eccentrically and connects the two transverse supports 33. The center of mass Ms and the centroid of the volume Vs of the support frame 30 diverge from each other due to the eccentric arrangement, as is shown in an exaggerated manner by the schematic representation.

FIG. 9 shows schematically in a cross-sectional view the arrangement of the central support 32 in the receptacle 42 of the lever arm 41. When compared to the state of the art (represented by a dotted line), the central support 32 is arranged in a laterally offset manner and in an offset manner in the direction of the elevation axis 102 with respect to the axis of rotation 102 configured as elevation axis. The offset is in particular an offset of the distances of the respective imaginary center lines, that is, of the center line of the receptacle 42 or the central support 32 to the elevation axis or the azimuth axis. The center line extends through the respective centroid of the volume or center of mass of the respective component or the respective recess or cavity.

FIG. 10 shows schematically in a side view the central support 32 with movable trapezoidal sheets 39. The trapezoidal sheets comprise a recess 39a configured as a passage opening which is adapted to the contour of the central support 32—here both are rectangular. The trapezoidal sheet 39 is configured to be plugged onto the central support 32 and to be movable along the central support 32. The trapezoidal sheet 39 is lockable when it has reached its desired position. There are provided several trapezoidal sheets 39 for the fixation of the solar modules.

FIG. 11 schematically shows in a top view the moving device 20 with the central support 32. Both the turning unit 40 with the axis of rotation 102 configured as elevation axis and the turning unit 50 with the axis of rotation 101 configured as azimuth axis (not shown here) are represented. Here it is clearly visible how the central support 32 is received and arranged in the receptacle 42 of the two lever arms 41 in a laterally fixed manner with respect to the elevation axis. The two bearing brackets 22 are arranged such that they do not exceed a width of the turning unit 50.

It is understood that the aforementioned features of the invention can not only be used in the respectively specified combination, but also in other combinations or on their own, without departing from the scope of the invention.

### LIST OF REFERENCE SIGNS

10 stand pillar
20 moving device
21 bearing unit
22 bearing bracket
23 axle element
24 bearing position
30 support frame
31 exterior frame
32 central support
33 support
33a longitudinal support
33b transverse support
38 rail unit
39 trapezoidal sheet
40 turning unit (elevation axis)
41 lever arm
42 receptacle
50 turning unit (azimuth axis)
51 actuator
100 tracking system
101 axis of rotation (azimuth axis)
102 axis of rotation (elevation axis)
110 actuator
Ms center of mass
Vs centroid of the volume
M center axis (central support)

What is claimed is:

1. A moving device for a tracking system of a solar system, in particular for moving an installation connected to the moving device according to a position of the sun, comprising at least one turning unit rotatable about at least one elevation axis with at least one receptacle for receiving the installation, wherein the turning unit and/or the receptacle is/are configured asymmetrically and/or eccentrically relative to at least the elevation axis.

2. The moving device according to claim 1, wherein the receptacle is arranged transversely relative to a direction from the elevation axis towards the installation, in particular laterally and/or in the opposite direction.

3. The moving device according to claim 1, wherein the turning unit comprises at least one overhanging lever arm.

4. The moving device according to claim 1, wherein at least one further moving unit is provided in order to move the attached installation in the direction of at least one further degree of freedom of the moving device.

5. The moving device according to claim 4, wherein one of the further moving units is configured as a motion drive which is rotatable at least about an azimuth axis.

6. The moving device according to claim 1, wherein the moving device comprises at least one bearing unit for rotatably bearing the turning unit.

7. The moving device according to 4, further comprising a bearing unit for rotatably bearing the turning unit, wherein the bearing unit and the at least one further moving unit are configured in an integrated manner.

8. An installation, in particular a solar installation, comprising at least one support structure pivotable about an elevation axis and/or at least one solar module, wherein the installation is configured asymmetrically with respect to the elevation axis.

9. The installation according to claim 8, wherein the support structure comprises a central support suitable to be received in the receptacle of the moving device.

10. The installation according to claim 9, wherein the central support is arranged asymmetrically and/or eccentrically relative to the installation, in particular with respect to a gravity center of the installation.

11. The installation according to claim 9, wherein the support structure comprises at least one further support connected to the central support.

12. A tracking system, in particular a solar tracking system, for tracking an installation according to a position of the sun, comprising at least one moving device and at least one installation, wherein the moving device is configured as a moving device according to claim 1 and/or the installation is configured as an installation according to claim 8.

13. The tracking system according to claim 12, wherein the installation is arranged asymmetrically on the moving device.

14. A solar system, in particular a solar system for photovoltaic, concentrating solar energy and/or a solar heat application, comprising at least one moving device and at least one installation coupled with the moving device with at least one solar system module, wherein the installation is configured as an installation according to claim 8 and/or the moving device is configured as a moving device according to claim 1.

15. A method for producing a tracking system, in particular a tracking system according to claim 12, for tracking at least one installation, in particular an installation according to claim 8, according to a position of the sun, wherein the installation is arranged on a moving device, in particular a moving device according to claim 1, wherein the installation is arranged asymmetrically on the moving device.
